(19) United States
(12) Patent Application Publication
(10) Pub. No.: US 2004/0157670 A1
(43) Pub. Date: Aug. 12, 2004

(54) Propshaft having multiple crash features

(76) Inventors: James Lyon, Edgeborough (GB); Darren Gregory, W. Midlands (GB)

Correspondence Address: DINNIN & DUNN, P.C., 2701 CAMBRIDGE COURT, STE. 500, AUBURN HILLS, MI, 48326, US

(21) Appl. No.: 10/769,958

(22) Filed: Feb. 2, 2004

Related U.S. Application Data
(60) Provisional application No. 60/445,733, filed on Feb. 6, 2003.

(51) Int. Cl. F16C 3/00

(52) U.S. Cl. 464/183

(57) ABSTRACT

A multi-piece propeller shaft for use in an automotive vehicle. The multi-piece propeller shaft including a first or front section and a second or rear section. The first section including a first crash feature in the form of a sliding spline. The second section including a second crash feature in the form of a collapsible constant velocity joint. The multi-piece propeller shaft capable of collapsing at predetermined loads and at predetermined times to have a tunable crash absorbing propeller shaft for use in automotive vehicles.

This is a continuation of Provisional Application 60/445,733 filed on Feb. 6, 2003

### BACKGROUND OF THE INVENTION

1. Field of the Invention

The present invention generally relates to vehicle propeller shafts and constant velocity joints, and more particularly relates to an improved propeller shaft and prop shaft that is crashworthy and has two or more separate crash features that will telescope the prop shaft in a controlled, tunable and predetermined manner during a crash event of a motor vehicle.

2. Description of Related Art

Propeller shafts (prop shafts) are well known in the art for use in vehicle propulsion systems. The prop shaft may be a multi-piece prop shaft or a solid prop shaft depending on the type of drive train system on the vehicle therein. The prop shafts are generally used to transfer torque and rotational forces to the rear axle and rear wheels in all wheel, four wheel or rear wheel drive vehicles. They also may be used with a front wheel drive vehicle and four wheel drive vehicles to deliver the necessary power to the front drive axle. The propeller shafts generally are supported by a center bearing having the necessary support bracketry. This will allow the drive shaft to rotate and transfer the necessary power to the front or rear axle of the automotive vehicle.

In recent years it has also become desirable for the propeller shaft of an automotive vehicle to be a more proactive piece of equipment designed for crashworthiness within the automotive vehicle. This crashworthiness also must be accompanied by prop shafts that are lighter in weight, less expensive and easier to manufacture and install. With regards to the crashworthiness of the prop shaft, generally during a crash of the vehicle the body will shorten and deform. Therefore, for safety reasons the propeller shaft should also be able to reduce its length during a crash event at or below a specified load. In the prior art this length reduction is generally achieved by having the prop shaft telescope to obtain a shorter over all length for the prop shaft. The ability of the prop shaft to collapse and telescope within itself will prevent the prop shaft from buckling which may lead to a penetration of the passenger compartment or damaging vehicle components in closed proximity to the propeller shaft such as gas tanks, drive axles, and other drive train components, etc. Some of the prior art multi-piece propeller shafts were designed to absorb a predetermined amount of energy under both high loads and low loads depending on the characteristics needed from the power shaft and the amount of energy needed to be absorbed in the propeller shaft. Many prior art vehicles are generally designed with crumple zones that will allow the vehicle to absorb energy at a predetermined rate during collision to prevent the transfer of such energy to the vehicle occupants within the passenger compartment. The amount of energy required to collapse the propeller shaft or telescope within itself is the amount of energy absorbed while the telescoping is active and will have an influence on the crumple zone performance of the vehicle during the collision event.

Some of the prior art propeller shafts will deform under certain loading conditions but many of these crash features that are designed in propeller shafts are often too complex and increase the cost of propeller shafts and constant velocity joints to unrealistic prices. Furthermore, the prior art prop shafts encounter obstacles when they are designed for relatively low collision or collapse forces because a strong and robust propeller shaft is required for every day use in modern day vehicles. Prior art collapsible propeller shafts tend to absorb energy in a one time manner and once they have collapsed they will no longer perform any energy absorbing characteristics which may be needed to further protect the passenger compartment of the automotive vehicle during the crash event. It should also be noted that the collapsing propeller shafts may rely on collapsible constant velocity joints, which allow the inner race and other components of a propeller shaft to be expelled through the bore of an outer race to allow the telescoping of the propeller shaft for the absorption of such energy in a crash event of an automotive vehicle.

It must also be noted that prior art propeller shafts are also designed to dynamically compensate for the change or modification in the distance between the transmission and the differential which occurs as the vehicle is driven. Hence, the propeller shaft includes a portion or a member which typically will move along a longitudinal axis of the propeller shaft in response to relative movement between the differential and transmission. Generally, in many prior art prop shafts the dynamic length modification is achieved by the use of spline members which normally are manufactured out of iron or any other commercially available material. These spline members are typically broached and machined onto the respective lengths of the members and intermeshingly cooperate to allow and/or cause the shaft to rotate around a yoke in response to rotation of the transmission, thereby allowing the transmission produced torque to be selectively coupled to a differential by the rotation of the yoke. It should be noted that the inner mesh splines will allow the shaft to be movable along the longitudinal axis of the propeller shaft thereby allowing the propeller shaft to dynamically compensate for changes in the distance between the transmission of the differential and allowing the prop shaft to desirably operate as the vehicle is driven.

Therefore, there is a need in the art for a collapsible multi-piece propeller shaft that is capable of being designed to control when and how large a collapsing force profile is during a crash event. There also is a need in the art to produce a propeller shaft that is easier to install, manufacture, is lighter in weight and reduces the costs of the propeller shaft in the drive train system. Furthermore, there is a need in the art for a multi-piece collapsible propeller shaft that includes two or more separate crash features that will telescope in a controlled, tunable, predetermined manner during a crash event. This will help to absorb energy at a variety of times during a crash event while helping to maintain the structural integrity of the automotive vehicle. There also is a need in the art for the use of a multi-piece collapsible propeller shaft used in conjunction with a constant velocity that is capable of collapsing thus reducing the costs of making and installing the unit into the automotive vehicle while also reducing any loss of containment of the passenger compartment of a vehicle during a crash event. There also is a need in the art for a multi-piece propeller shaft that is capable of using a variety of design crash features arranged either in the front section or rear section or both of a propeller shaft in an automotive vehicle. These multiple crash features must also be selectively tunable to activate during specific times and at specific loads of a crash event.

### SUMMARY OF THE INVENTION

One object of the present invention is to provide an improved propeller shaft for an automotive vehicle.

Another object of the present invention is to provide a propeller shaft that has a double collapse zone manufactured therein.

Yet a further object of the present invention is to provide a propeller shaft that will collapse in a safe and controlled manner during a crash event.

Still another object of the present invention is to provide a propeller shaft that is capable of being designed to absorb crash energy while also reducing the chance of debris and other material from intruding into the passenger cabin.

Still another object of the present invention is to provide a propeller shaft that is capable of being designed and tuned to positively effect the vehicle crash signature including but not limited to activating a crash feature in the prop shaft while a second crash feature in the prop shaft is not activated.

Still another object of the present invention is to provide a propeller shaft that has a maximum crash plunge distance equal to the combined total crash plunge distances of each crash feature allowing for greater crash plunge distance.

Still another object of the present invention is to provide a propeller shaft that improves NVH characteristics and reduces the weight of the propeller shaft in the automotive vehicle drive train.

Yet another object of the present invention is providing a propeller shaft that may use individually shorter tube sections but still has a large plunge requirement via collapsing of two or more areas in the propeller shaft crash zones.

Still another object of the present invention is the use of a prop shaft that has numerous sections each including at least one or more crash features located in each individual section of the prop shaft thus increasing the tunability of the crashworthiness and crash absorption characteristics of the prop shaft for the automotive vehicle.

Yet another object of the present invention is to provide a crash feature for a propeller shaft that can activate under greater bending moments and activate under greater torque requirements.

To achieve the foregoing objects, an improved multi-piece prop shaft with multiple crash features is disclosed. The multi-piece prop shaft includes a first section connected via a carden joint, center bearing or other type of joint to a second section. Each of the sections generally have a tube-like shape and on their outer ends are connected via carden joints or other known joints to slip yokes or flanges and then onto a transmission and/or differential. The first section and second section of the multi-piece propeller shaft are capable of linear movement relative to one another and may be any of numerously known types of spline shafts, such as but not limited to female splines, male spline tube shafts, female muff spline tube shafts or the like. It should further be noted that other contemplated embodiments include a collapsible constant velocity joint used as a crash feature in the multi-piece propeller shaft. It should also be noted that any combination of such described crash features may also be used in the multi-piece propeller shaft.

One advantage of the present invention is that it provides an improved multi-piece propeller shaft for use in an automotive vehicle.

Still another advantage of the present invention is that it provides propeller shaft having a double collapse zone.

Still another advantage of the present invention is that the multi-piece propeller shaft is designed and tuned to meet requirements for specific automotive applications.

Yet another advantage of the present invention is that the propeller shaft will collapse in a safe and controlled manner during a crash event with reduced incidence of debris and intrusion into the passenger compartment of the automotive vehicle.

Still another advantage of the present invention is that the multi-piece propeller shaft can be designed to absorb crash energy and tuned to positively effect the vehicle crash signature.

Still another advantage of the present invention is that the propeller shaft is capable of activating one crash feature if the other crash feature does not activate.

Still another advantage of the present invention is that the multi-piece propeller shaft has a maximum crash plunge distance equal to the combined total crash plunge distances of each crash feature aligned for greater crash plunge distance.

Yet another advantage of the present invention is that the propeller shaft reduces the weight and improves NVH characteristics of the propeller shaft in the automotive vehicle.

Still another advantage of the present invention is that the propeller shaft may be designed with relatively short tube sections while still having a large crash plunge requirement fulfilled by separating the collapse of the prop shaft over two or more areas of the individual tube sections.

Still another advantage of the present invention is that the propeller shaft can be used on four or greater piece prop shafts by locating one or more crash features in each section or piece of the multi-piece propeller shaft.

Yet another advantage of the present invention is the multi-piece propeller shaft includes crash features that can operate under greater bending moments and also activate under greater torque requirements.

Other objects, features and advantages of the present invention will become apparent from the subsequent description and the appended claims, taken in conjunction with the accompanying drawings.

### BRIEF DESCRIPTION OF THE DRAWINGS

FIG. 1 shows a side view of a multi-piece propeller shaft according to the present invention.

FIG. 2 shows a cross section of the multi piece propeller shaft of FIG. 1 taken along line 2-2.

FIG. 3 shows a side view of an alternate embodiment of a multi-piece propeller shaft according to the present invention.

FIG. 4 shows a cross section of the multi piece propeller shaft of FIG. 3 taken along line 4-4.

FIG. 5 shows a side view of a multi-piece propeller shaft according to another alternate embodiment of the present invention.

FIG. 6 shows a cross section of the multi piece propeller shaft of FIG. 5 taken along line 6-6.

FIG. 7 shows a side view of another alternate embodiment of a multi-piece propeller shaft according to the present invention.

FIG. 8 shows a cross section of the multi piece propeller shaft of FIG. 7 taken along line 8-8.

FIG. 9 shows a side view of yet another alternate embodiment of a multi-piece propeller shaft according to the present invention.

FIG. 10 shows a cross section of the multi piece propeller shaft of FIG. 9 taken along line 9-9.

### DESCRIPTION OF THE EMBODIMENT(S)

Referring to the drawings, a multi-piece propeller shaft 10 according to the present invention is shown. The multi-piece crashworthy propeller shaft 10 is for use on any known drive train system including rear wheel drive systems, front wheel drive systems, all-wheel drive systems and four wheel drive systems. Generally, the prop shaft 10 is used on an all wheel drive or four wheel drive system or rear wheel drive system wherein the multi-piece propeller shaft 10 will connect the transmission and a rear differential. The multi-piece propeller shaft 10 will allow for rotational torque velocities to be moved from the transmission to the differential and then through side shafts onto the automotive vehicle wheels. The multi-piece propeller shaft 10 generally will be capable of movement along an axis thereof relative to its multiple pieces or sections thus allowing for and compensating for any movement or length differential between the transmission and rear differential during normal operation of the vehicle. It should be noted that the multi-piece propeller shaft 10 can be used with any variety of known or contemplated crash features. As long as the crash features are capable of telescoping or reducing the length of the prop shaft in a controlled, tunable and predetermined manner during a crash event for the motor vehicle. These crash features include but are not limited to crashworthy sliding splines, crashworthy constant velocity joints, other crash features, crashworthy stops or grease caps, etc., and any other known or contemplated crash features that may be incorporated into a multi-piece propeller shaft 10. It should be noted that the same crash features may be incorporated into a multi-piece propeller shaft 10 between a transmission and a front differential for a front wheel drive vehicle or all wheel drive vehicle.

The above-identified invention can be used on any typical driveline of an automotive vehicle. A typical driveline of a motor vehicle may be an all-wheel drive vehicle driveline. However, it should be noted that the constant velocity joints and multi-piece propeller shaft 10 of the current invention may also be used on rear-wheel drive vehicles, front-wheel drive vehicles, all-wheel drive and four-wheel drive vehicles. The driveline typically includes an engine that is connected to a transmission on a power take off unit. The driveline includes a front differential and includes a left hand front half shaft and a right hand front half shaft each of which are connected to a wheel and deliver power to the wheels. On both ends of the left front half shaft and right front half shaft are constant velocity joints. The propeller shaft connects the front differential to the rear differential. The rear differential includes a left hand rear half shaft and a right hand rear half shaft each of which is connected to a wheel on an end thereof. A constant velocity joint is located on both ends of the right hand rear half shaft and left hand rear half shaft that connect to the rear differential. The propeller shaft 10 is a multi-piece propeller shaft that includes a plurality of carden joints and at least one high speed constant velocity joint. The constant velocity joint may be a crashworthy collapsible type. The constant velocity joints transmit power to the wheels and to the half shaft assemblies even if the wheels or the shaft have changing angles due to steering, raising or lower of the suspension of the vehicle. The constant velocity joints may be of any of the standard types known, such as plunging tripod, cross groove joint, fixed joint, a fixed tripod joint, a double offset joint, collapsible joint or any other known constant velocity joint. It should also be noted that the above are commonly known terms in the art. The constant velocity joints will offer transmission of constant velocities at angles that are encountered in every day driving of automotive vehicles on both the half shaft assemblies and the prop shaft assemblies of these vehicles.

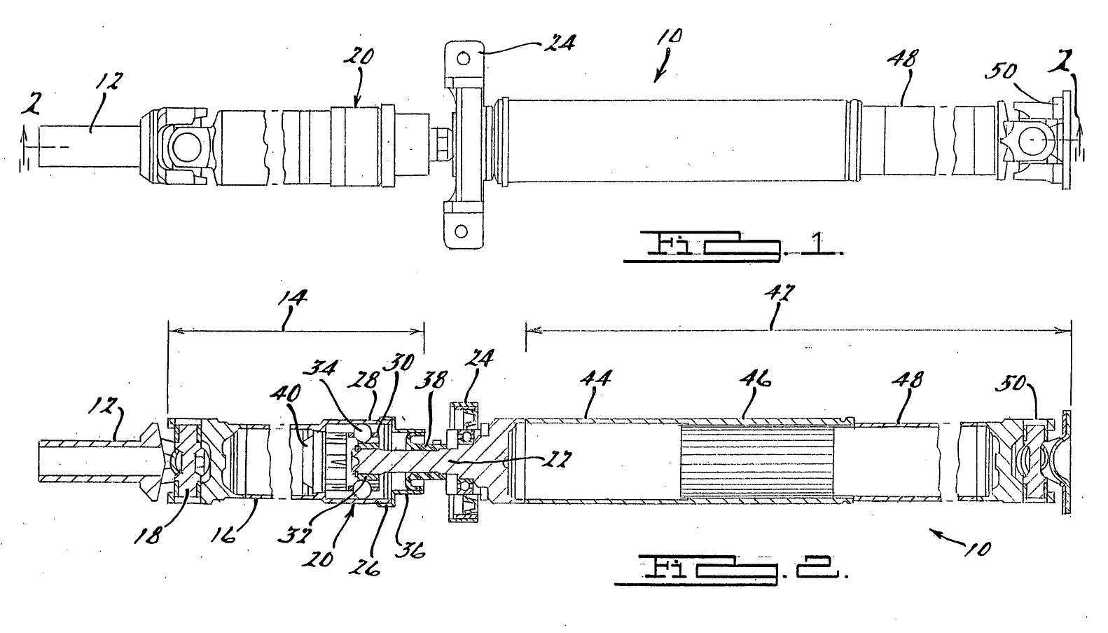

FIGS. 1 and 2 show a multi-piece collapsible propeller shaft 10 according to the present invention. The propeller shaft 10 in this embodiment is arranged between a transmission and a rear differential thus forming a rear propeller shaft for an automotive vehicle. The multi-piece propeller shaft 10 includes a slip yoke member 12 on one end thereof. The slip yoke member 12 is connected to the transmission or rear differential depending on the design requirements of the automotive vehicle. The slip yoke member 12 will be connected to a first or front section 14 of the propeller shaft 10. The first propeller section 14 includes a tube 16 connected to a Carden or other type joint 18 on one end thereof. The tube 16 is connected to a crashworthy constant velocity joint 20 at the opposite end. The tube 16 is either welded or connected via any other known means to the constant velocity joint 20 and the Carden joint 18. The constant velocity joint 20 may be any type known but in this particular embodiment is a collapsible joint. The constant velocity joint 20 in this embodiment includes a stub shaft 22 is rotatably fixed with the constant velocity joint 20 and is rotatably supported by a center bearing on the joint 24 of the multi-piece propeller shaft 10. The constant velocity joint 20 includes an outer race 26 having a generally ring like appearance. The outer race 26 includes a plurality of circumferential channels located on the outside surface thereof. The outer race 26 has a shoulder portion which has a sleeve 28 welded or attached by any other known securing means thereto. It should also be noted that the sleeve and outer race may be one solid piece formed without any welding or other connecting means necessary. The outer race 26 is generally made of a steel material, however it should be noted that any other metal material, hard plastic, composite or ceramic may also be used depending on the design requirements of the constant velocity joint and the vehicle.

A roller cage 30 is arranged within a bore of the outer race 26 of the constant velocity joint 20. The roller cage 30 includes a plurality of orifices through a surface thereof. An inner race 32 is arranged within the roller cage 30 and includes a bore therethrough. The bore includes a plurality of splines or teeth on an inner surface thereof for connecting with the stub shaft 22. The stub shaft 22 and the inner race 32 are rotatably fixed with respect to one another. A plurality of torque transmitting balls 34 are arranged between an inside surface of the outer race 26 and an outer surface of the inner race 32. The balls 34 are arranged within the orifices of the roller cage 30 to ensure the balls 34 stay within the designated ball track on the outer race 26 and inner race 32 thereof, respectively. It should be noted that the roller cage 30, the balls 34, and the inner race 32 are all made of a steel material in one embodiment but that it has been contemplated to use any other metal material, ceramic, hard plastic or composite material for use of these parts within the constant velocity joint 20.

A boot cover 36 is connected to one end of the outer race 26 by any known securing means. The boot cover 36 generally has a sleeve like appearance and may be connected in one or more of the outer circumferential channels located on the outer surface of the outer race 26. The opposite end of the boot cover 36 is connected to a boot 38 which contacts the stub shaft 22 on the opposite end thereof. The boot 38 is preferably made of a pliable material such as urethane. However, it should be noted that any other pliable material such as rubber, plastic, composites or fabric may be used for the boot. Material must be able to withstand the high temperatures and high speed rotation of the constant velocity joint 20 while still staying pliable to accommodate any changes and angles of the constant velocity joint 20 due to driving variances of the automotive vehicle. The constant velocity joint 20 is sealed with lubricant for life. Generally, the lubricant is a grease which acts to lubricate the rotating internal parts of the constant velocity joint 20 while also reducing the temperature within the joint itself. Connected on an opposite end of the outer race 26 from the boot cover 36 is the hollowed tube shaft portion 26 of the multi-piece propeller shaft 10 which is either welded or connected by any other known securing means to the outer race 26.

A grease cap 40 is also arranged within or near an outer race 26 shoulder portion that includes a radially inward extending shelf. Generally, the grease cap 40 will be arranged within the shoulder portion against the inner surface of the outer race.

The constant velocity joint 20 as shown in FIG. 1 is a collapsing constant velocity joint that will collapse when a predetermined axial load is applied thereto. The inner race 32, stub shaft 22, roller cage 30 and torque transmission balls 34 will move in an axial direction towards the end of the outer race 26 having the grease cap 40 when the axial load is applied. The stub shaft 22 and inner race 32 will first engage with and break through or dislodge the grease cap 40 and continue to travel in an axial direction through the bore of the outer race with the roller cage 30 and torque transmitting balls 34 following behind the stub shaft 22 and inner race 32. This will allow the constant velocity joint 20 to be designed with a predetermined force profile to create specific crash profiles for use in improving and controlling the crashworthiness of the automotive vehicle. It should be noted that the outer race 26 may be designed such that it is one piece and does not include two pieces having a separate piece welded thereon as described above. It should also be noted that the constant velocity joint 20 that is collapsible as described above is used in this embodiment but any other known collapsible constant velocity joint may also be used as a crash feature in the multi-piece propeller shaft described. The stub shaft 22 is supported by the center bearing 24 on the end opposite from the tube 16 of the first section 14. A second or rear section 42 of the multi-piece propeller shaft 10 is connected to an end of the stub shaft 22 opposite the collapsible constant velocity joint 20.

The second or rear section 42 of the collapsible multi-piece propeller shaft 10 includes a female spline 44 having a female muff spline 46 connected to an end thereof. It should be noted that generally the female spline 44 and the female muff spline 46 are connected via a weld but any other known securing means can be used. The female spline 44 and female muff spline 46 generally have a tube-like shape and will have a predetermined diameter of approximately between a half inch up to ten inches. It should be noted that the tube 16 in the first section 14 also has a diameter of approximately between one half inch up to ten inches depending on the design requirement.

It should further be noted that the female spline 44, the female muff spline 46. the male splines and tube 16 can be made of any hard steel, iron material or even aluminum along with any other type of metal, hard plastic, ceramic or composite depending on the design requirements of the automotive vehicle. The female muff spline 46 is well known in the art and is generally made from a forging that has teeth broached into it and is thereafter welded or connected via any other known securing means to the end of the female spline tube 44 as shown. Arranged within the female muff spline 46 and partially within the female spline 44 is a male tube spline 48. The male tube spline 48 also is designed such that it may have a diameter of approximately one half inch up to ten inches. The male tube spline 48 generally includes splines formed directly on the tube. The opposite end of the male tube spline 48 is welded and secured via any other known securing means to a flange or other type of joint 50. The male spline 48 will have a plurality of splines/teeth located on the outer surface thereof while the female muff spline 46 will have a plurality of splines or teeth arranged on an inside surface but may be formed such that the teeth occur on both the outer surface and inner surface along with the male spline which may have the teeth or spline occurring on the outer surface and inner surface depending on the method used to form the splines onto the tube sections. The male spline 48 will be placed and arranged within the female muff spline 46 such that the splines on the male tube spline 48 and the splines on the female muff spline 46 interact and interconnect with each other in a radial direction. This will still allow for axial movement and adjustment of the propeller shaft 10 for any axial movement relative to the rear differential and the transmission during operation of the automotive vehicle. The flange 50 will be connected to the rear differential or transmission via a driving gear.

In operation the propeller shaft 10 of FIG. 1 may be tuned such that the crashworthy female sliding spline 44, 46 at the rear section 42 will activate on one load condition while the collapsible constant velocity joint 20 will collapse at a second load condition thus allowing for multiple crashing absorbing methods and absorption rates. It should also be noted that it is contemplated to have a design such that the collapsible constant velocity joint 20 collapses first while the female sliding spline 44, 46 actives second or it can occur in reverse order with the female sliding spline 44, 46 activating first and the collapsible constant velocity joint 20 activating second or even in another contemplated embodiment both the collapsible constant velocity joint 20 and the female sliding spline 44, 46 activate at the same load thus increasing the crash absorbing characteristics during the predetermined crash event.

It should be noted that each crash feature, including the crashworthy constant velocity joint 20 and the female sliding spline 44, 46 as shown in FIG. 1 are designed to have a one hundred millimeter collapse feature for each individual feature. However, it should be noted that the collapse feature can be anywhere from approximately ten millimeters to 1000 millimeters depending on the vehicle size and type of crash protection needed.

It should also be noted that the length of the splines on both the female muff spline 46 and the male spline 48 could be approximately one inch long to thirty inches long which will allow for more play between the tube sections during actual vehicle driving maneuvers and during crash events. This would allow for more control and better crash absorbing techniques depending on the design of the actual splines including but not limited to the included angle between each spline and any angle of a spline taken along an axial reference. Therefore, the splines may be adjusted such that they are inclined at angles opposite to one another thus increasing the crash absorption characteristics during the collapsing of a sliding spline 46, 48 crash feature.

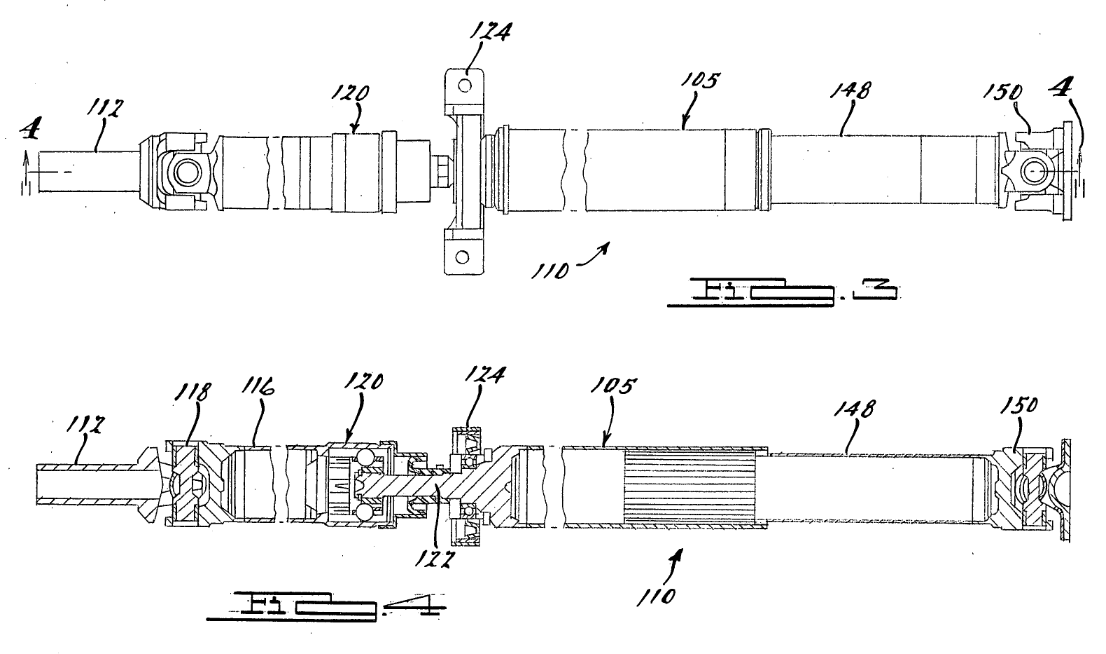

FIGS. 3 and 4 show an alternate embodiment of the multi-piece collapse prop shaft 110 according to the present invention. Like numerals indicate like parts. FIG. 2 includes a slip yoke 112 connected to a transmission or rear differential depending on the design requirements of the multi-piece propeller shaft 110. A Carden joint 118 is connected to the slip yoke 112 on one end thereof. The opposite end of the Carden joint 118 is connected to a first or front section 114 of the multi-piece propeller shaft 110. The first section 114 of the multi-piece propeller shaft 110 includes a tube section 116 connected to the Carden joint 118 on an end and to a collapsible constant velocity joint 120 at the opposite end of the tube 116. It should be noted 116 that the tube and constant velocity joint 120 are the same as those described above and the same parameters apply thereto. The constant velocity joint 120 is then connected to a stub shaft 122. The stub shaft 122 is rotatably supported by a center bearing 124. The stub shaft 122 is then connected to a female tube spline 105 on the opposite end thereof. The female tube spline 105 is welded or connected via any other known means to the stub shaft 122. The connecting joint in this embodiment is a center bearing. The female tube spline 105 will have splines formed therein and will have the same parameters as those discussed above for the male spline 118 or female muff spline 46 including any known pitch, diameter between the teeth of the splines and any known included angle for each spline anywhere from zero to 90 degrees. It should further be noted that the splines may have an iodized aluminum or cold formed spline portions or any other method of hardening the splines if necessary for the design requirements.

A male tube spline 148 such as that described above for FIG. 1 will be arranged within the female tube spline 105 and will allow for axial movement between the female tube spline 105 and the male tube spline 148 but will fix these two members in a rotational direction to one another. The male tube spline 148 will be connected via a weld or any other known connecting mechanism to a flange 150 at the opposite end thereof. This alternate embodiment of the multi-piece propeller shaft 110 will operate in the same method as described above with either one or both of the crash features, in the first and second sections of the multi-piece propeller shaft 110, activating before the other or activating at the same time depending on the needs and requirements as discussed above.

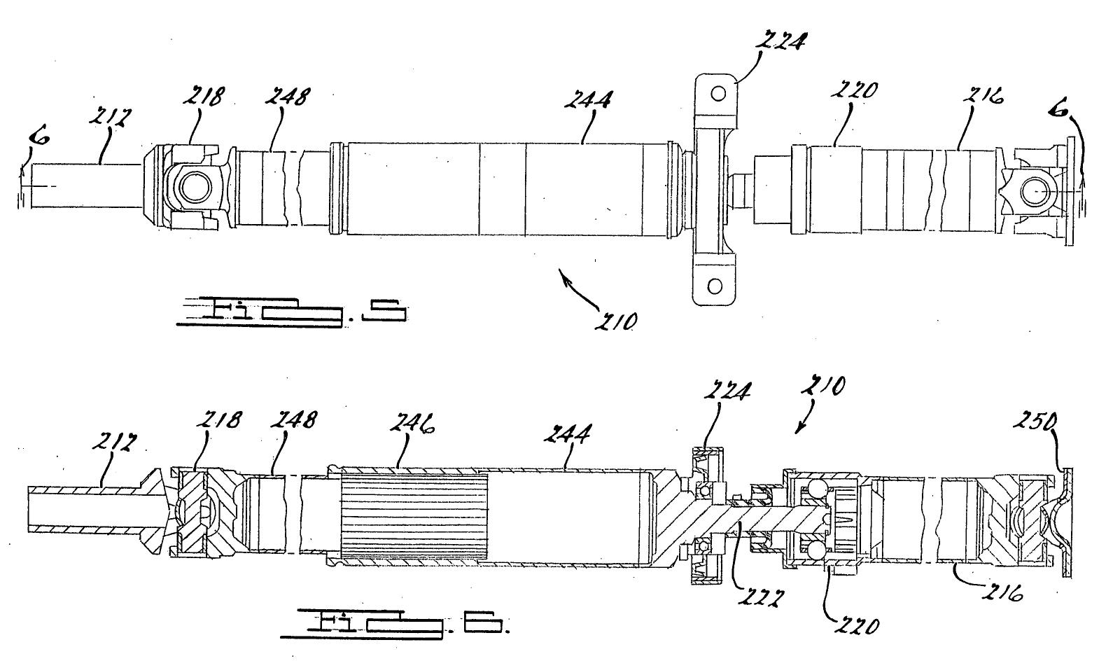

FIGS. 5 and 6 show yet another embodiment of the multi-piece propeller shaft 210 according to the present invention. Like numerals indicate like parts. In this embodiment a slip yoke 212 is connected to a universal Creden joint 218 on one side and the first or front section 214 is connected to the universal Carden joint 218 on the opposite side thereof. The first section 214 includes a male tube spline 248 welded or secured by any other known means to the Carden joint 218. A female muff spline 246 is connected to a female spline 244 such that the male tube spline 248 is arranged within the female muff spline 246. The female spline 244 is connected to an end of a stub shaft 222. The male spline 248 is arranged within the female muff spline 246 such that axial movement is capable but not radial movement between the female muff spline 246 and the male tube spline 248. The stub shaft 222 is arranged within a center bearing 224 of the collapsible multi-piece propeller shaft 210. On the opposite end of the stub shaft 222 is arranged a collapsible constant velocity joint 220. The collapsible constant velocity joint 220 has a tube section 216 arranged on the end opposite of the center bearing 224. The tube section 216 is then connected on its end opposite of the constant velocity joint 220 to a flange 250 and then onto a rear differential or transmission depending on the design requirements of the automotive vehicle. It should be noted that the collapsible constant velocity joint 220 and tube section 216 represent the rear section or second section 242 of the multi-piece propeller shaft 210. The same parameters apply as described above for the collapsible constant velocity joint and female/male spline crash systems.

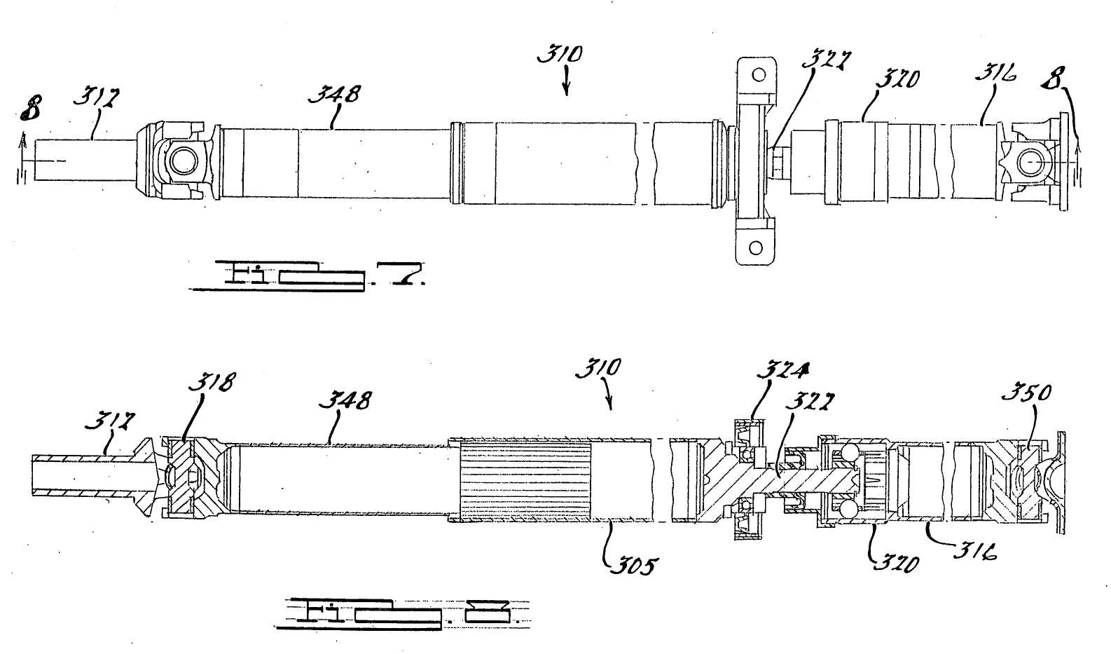

FIGS. 7 and 8 show yet another alternate embodiment of the present invention. Like numerals indicate like parts. The embodiment in FIG. 7 includes a slip yoke 312 connected to a Carden joint 318 on one end thereof and a first or front section 314 of a multi-piece propeller shaft 310 on the opposite end of the Carden joint 318. The first section 314 includes a male tube spline 348 connected to the end of the Carden joint. The male tube spline 348 is arranged within a female tube spline 305 on one end thereof while the opposite end of the female tube spline 305 is connected via welding or any other known securing method to an end of a stub shaft 322. The stub shaft 322 is supported by a center bearing 324. The second or rear section 342 of the multi-piece propeller shaft 310 is engaged with the stub shaft 322. The stub shaft 322 is engaged with a collapsible constant velocity joint 320 on the end opposite of the female tube spline 305. The crashworthy constant velocity joint 320, which is collapsible, has a tube section 316 connected to an end thereof while the opposite end of the tube section 316 is connected to a flange 350 which is further connected to a rear differential or transmission depending on the design requirements of the multi-piece propeller shaft.

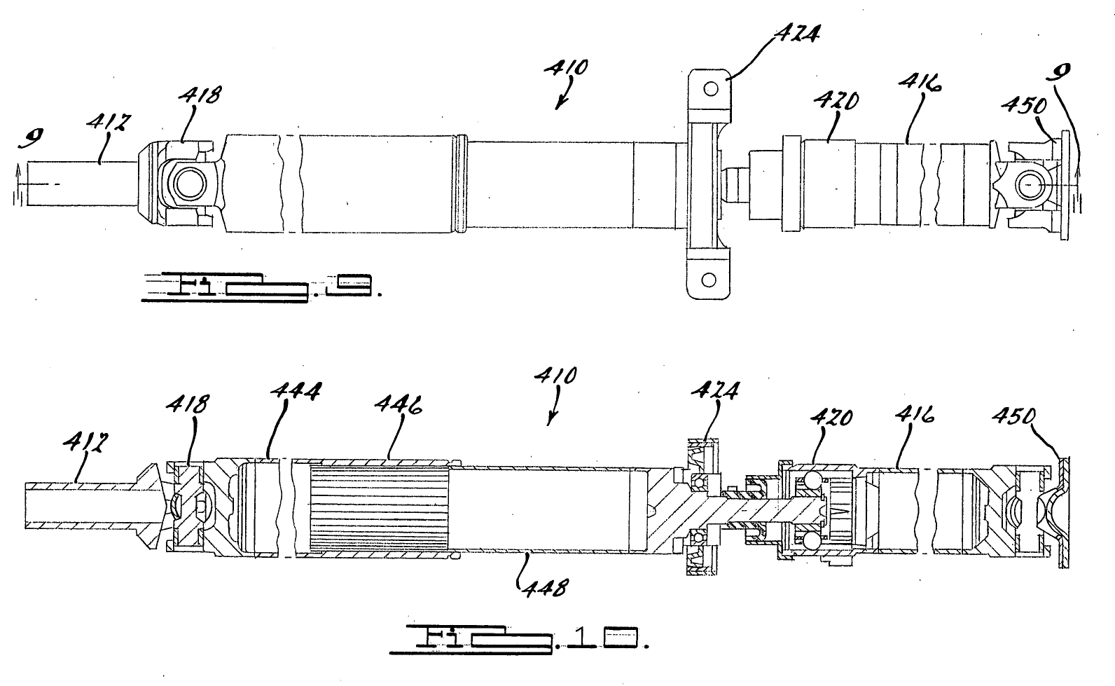

FIGS. 9 and 10 show yet another alternate embodiment of the multi-piece collapsible propeller shaft 410 according to the present invention. Like numerals indicate like parts. The multi-piece propeller shaft 410 includes a slip yoke 412 connected either to a transmission or a differential on one end thereof. The opposite end of the slip yoke 412 is connected to a universal Carden joint 418. A first section 474 of the multi-piece collapsible propeller shaft 410 is connected to the opposite end of the Carden joint 418. The first section 414 of the collapsible multi-piece propeller shaft 410 is connected to a center bearing 424 on an opposite end thereof. The center bearing 424 has a second section or rear section 422 of the multi-piece propeller shaft 410 connected to the opposite end thereof and extends from the center bearing 424 in the opposite direction. The first section 414 of the multi-piece collapsible propeller shaft 410 includes a female tube spline 444 connected to the Carden joint 418 by welding or any known securing means. A female muff spline 446 is formed and then welded or connected via any other known securing means to an end of the female spline 444. A male tube spline 448 is formed and then arranged within the female muff spline 446 on one end thereof while the opposite end of the male spline 448 is welded or connected via any other known securing means to an end of a stub shaft 422. The stub shaft 422 is rotatably supported by a center bearing 424. The stub shaft 422 is rotatably connected on the opposite end thereof to a collapsible constant velocity joint 420. On the opposite side of the collapsible constant velocity joint 420 is attached a tube section 416. The tube section 416 is connected on the end opposite thereof to a flange 450 which is connected either to a rear differential or a transmission depending on the design requirements of the alternate embodiment of the collapsible multi-piece propeller shaft 410.

It should be noted that it is possible for a female/male sliding spline to be attached to a rear Cardan which is not shown in the above noted embodiments. It should also be noted that any combination of female tubes splines 105 and female muff splines 116 can be used and that either may be used depending on the weight, bending frequency and packaging requirements of the automotive vehicle. It should also be noted that collapsible constant velocity joints 20 may be used in both the rear section and front section of the multi-piece collapsible propeller shaft 10 as discussed above. It should also be noted that sliding splines female or male may both be used in both the front section and rear section of the multi-piece collapsible propeller shaft 10 on their own. Any lengths splines and diameters of the tube sections are capable as described above. Furthermore, angling of the splines relative to one another to increase crash absorption characteristics and other characteristics are also possible. Therefore, any of the crash features, i.e., collapsible constant velocity joint 20 or sliding spline may be used in any position of the front section or rear section of a multi-piece propeller shaft and at either end of the front or rear section, i.e., the transmission side, differential side or center joint side of the multi-piece propeller shaft. Furthermore, any of the crash features can be used in any orientation.

It should be noted that the propeller shaft shown in the figures use a collapsible constant velocity joint and a sliding spline in a variety of arrangements but this invention is in no way limited to those shown and in fact are only some of the many contemplated ways of preparing a multi-piece propeller shaft 10 capable of collapsing at different intervals and with different crash absorption characteristics. As noted above, sliding splines may be used exclusively, collapsible constant velocity joints may be used exclusively, a combination may be used as described in the drawings. It should also be noted that a multi-piece propeller shaft may have more than two-piece shafts and that in each multi-piece propeller shaft a minimum of one crash feature will be included in each section of the multi-piece propeller shaft in a contemplated embodiment. In the multi-piece propeller shaft having two or more sections it is envisioned to have a combination of collapsible constant velocity joints 20 along with sliding splines in some embodiments while also having exclusively sliding splines in another embodiment, and even including only collapsible constant velocity joints in yet another embodiment. Therefore, a variety of designs are contemplated for a multi-piece propeller shaft having numerous crash feature collapsible sections using any variety of known crash features within that multi-piece propeller shaft. It should further be noted that there is also a contemplated embodiment where one or more crash feature is located in each section of any number section multi-piece propeller shaft. Therefore, a collapsible constant velocity joint or slip spline may be located in a front section of a multi-piece propeller shaft while the rear section of a two-piece multi-piece propeller shaft may have two collapsible constant velocity joints therein or any other arrangement known or even no crash features therein.

The forces at which each crash feature activates can be tuned to the vehicle needs such as but not limited to: 1) the forces are equal to each other; 2) one of the forces is much greater than the other; 3) one of the forces is less than the other; 4) or 5) one of the forces is much less than the other. A prop shaft 10 according to the present invention can activate crash features at many different times and with many different parameters to allow for a tunable vehicle to meet a variety of needs of the automotive manufactures. The crash features also can activate under greater bending moments and activate under greater torque. As an example, if one of the two-piece prop shafts described above is subject to a bending moment and/or torque the sliding spline will have a high resistance to plunging. The collapsible constant velocity joint thus will collapse first this will reduce the bending moment of the propeller shaft which will allow the front section to spin inside the rear section and reduce the torque. Thus the tube spline will then be able to crash plunge after the constant velocity joint has collapsed.

The present invention has been described in an illustrative manner. It is to be understood that the terminology which has been used is intended to be in the nature of words of description rather than of limitation.

Many modifications and variations of the present invention are possible in light of the above teachings. Therefore, within the scope of the appended claims, the present invention may be practiced otherwise than as specifically described.

What is claimed is:

1. A collapsible multi-piece propeller shaft, said propeller shaft including:
a first collapsible tube like section, said first tube like section having a crash feature integrated therein;
a second collapsible tube like section connected to said first collapsible tube like section at or near one end thereof, said second collapsible tube like section having at least one crash feature integrated therein.

2. A collapsible multi-piece shaft, said shaft including:
a first collapsible section having a crash feature integrated therein; and
a second collapsible section connected to said first collapsible section at or near an end thereof, said second collapsible section having at least one crash feature integrated therein.

3. The shaft of claim 2 wherein said first collapsible section having a tube connected to a joint on one end.

4. The shaft of claim 3 wherein said first collapsible section having a collapsible constant velocity joint connected to another end of said tube.

5. The shaft of claim 2 wherein said second collapsible section having a tube connected to a flange or joint on one end.

6. The shaft of claim 5 wherein said tube having a female muff spline engaging a male spline.

7. The shaft of claim 6 wherein said tube having a female spline secured to said female muff spline.

8. The shaft of claim 7 wherein said female spline connected to a shaft, on one end, said shaft connected to said first collapsible section on an opposite end thereof.

9. The shaft of claim 5 wherein said tube having a female tube spline, said female tube spline having splines formed on an inside surface thereof.

10. The shaft of claim 9 wherein said tube having a male spline, said male spline engaging said female tube spline.

11. A multi-piece collapsible propeller shaft for use in an automotive vehicle, said multi-piece propeller shaft including:
a first collapsible section, said first collapsible section including a male tube spline and a female tube spline, said female and male tube spline form a first crash feature; and
a second collapsible section having a collapsible constant velocity joint, said collapsible constant velocity joint forms a second crash feature.

12. The multi-piece propeller shaft of claim 11 wherein said second collapsible section having a tube, said tube connected to said collapsible constant velocity joint on one end and to a flange or joint on an opposite end thereof.

13. The multi-piece propeller shaft of claim 12 wherein said first collapsible section having a female muff spline connected to said female spline.

14. The multi-piece propeller shaft of claim 13 wherein said male spline is arranged within said female muff spline on one end and connects to a joint on an opposite end.

15. The multi-piece propeller shaft of claim 14 wherein said female spline is connected to a stub shaft, said stub shaft engaged with said collapsible constant velocity joint on one end.

16. The multi-piece propeller shaft of claim 13 wherein said female spline is connected to a joint on one end and said female muff spline is arranged around said male spline on one end.

17. The multi-piece propeller shaft of claim 16 wherein said male spline is connected to a stub shaft, said stub shaft engaged with said collapsible constant velocity joint on one end.

18. The multi-piece propeller shaft of claim 12 wherein said male tube spline is arranged within said female tube spline, said female tube spline is rotatably fixed to said male tube spline, said male tube spline is axially moveable with respect to said female tube spline.

19. The multi-piece propeller shaft of claim 18 wherein said male tube spline is connected to a joint on one end.

20. The multi-piece propeller shaft of claim 19 wherein said female tube spline is connected to a stub shaft on one end, said stub shaft engaged with said second collapsible section.
